(19) United States
(12) Patent Application Publication
(10) Pub. No.: US 2021/0378208 A1
(43) Pub. Date: Dec. 9, 2021

(54) Ferret Cage Assembly

(71) Applicant: Joshua Tatum, Lawton, OK (US)

(72) Inventor: Joshua Tatum, Lawton, OK (US)

(21) Appl. No.: 16/895,333

(22) Filed: Jun. 8, 2020

(51) Int. Cl. A01K 1/03

(52) U.S. Cl. CPC A01K 1/03

(57) ABSTRACT

A ferret cage assembly for facilitating a ferret to live in captivity includes cage has a front door, a food door, a litter door, a first floor and a second floor. A lower den is positioned within the cage and the lower den is positioned on the first floor. A ramp extends between the first floor and the second floor to facilitate the ferret to travel between the first floor and the second floor. A litter box is removably positioned in the cage to contain ferret waste. An upper den is positioned within the cage and the upper den is positioned on the second floor. A tunnel is positioned within the cage to have the ferret crawl therethrough to simulate the ferret's natural behavior.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cage devices and more particularly pertains to a new cage device to facilitate a ferret to live in captivity.

### (2) Description of Related Art Including Information Disclosed Under 37 CFR 1.97 and 1.98

The prior art relates to cage devices including a variety of animal housings that include a plurality of intersecting tubes to facilitate an animal to crawl therethrough. The prior art discloses a variety of animal housings that have multiple floors and a vertical tube extending between each of the multiple floors. Additionally, the prior art discloses a variety of animal housings that comprise a plurality of tanks being interconnected by a plurality of tunnels. The prior art also discloses an animal housing that has a safety door which angles between an upper floor and a lower floor for selectively closing off a portion of the animal housing.

### BRIEF SUMMARY OF THE INVENTION

An embodiment of the disclosure meets the needs presented above by generally comprising a cage has a front door, a food door, a litter door, a first floor and a second floor. A lower den is positioned within the cage and the lower den is positioned on the first floor. A ramp extends between the first floor and the second floor to facilitate the ferret to travel between the first floor and the second floor. A litter box is removably positioned in the cage to contain ferret waste. An upper den is positioned within the cage and the upper den is positioned on the second floor. A tunnel is positioned within the cage to have the ferret crawl therethrough to simulate the ferret's natural behavior.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a ferret cage assembly according to an embodiment of the disclosure.

FIG. 2 is a front perspective view of an embodiment of the disclosure.

FIG. 3 is a left side perspective view of an embodiment of the disclosure.

FIG. 4 is a right side perspective view of an embodiment of the disclosure.

FIG. 5 is a cross sectional view taken along line 5-5 of FIG. 1 of an embodiment of the disclosure.

FIG. 6 is a cross sectional view taken along line 6-6 of FIG. 5 of an embodiment of the disclosure.

FIG. 7 is a cross sectional view taken along line 7-7 of FIG. 5 of an embodiment of the disclosure.

### DETAILED DESCRIPTION OF THE INVENTION

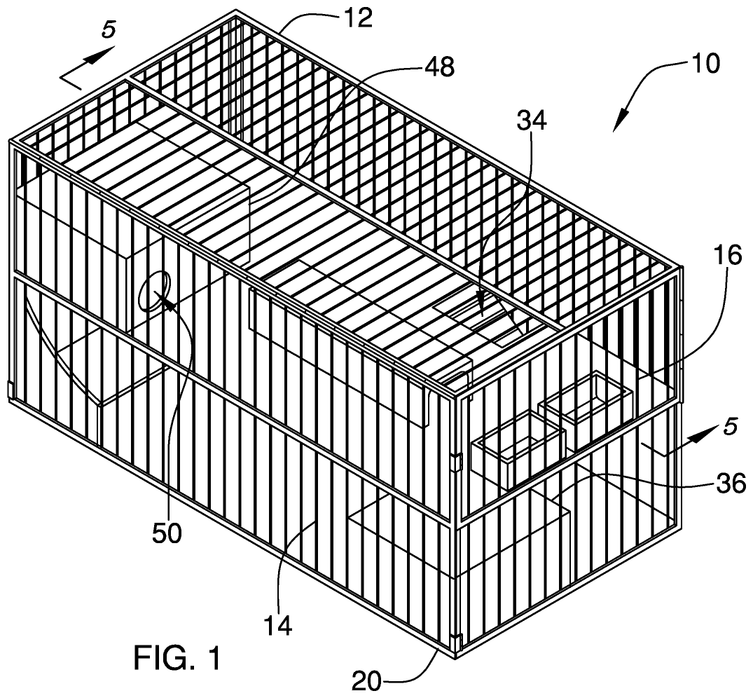

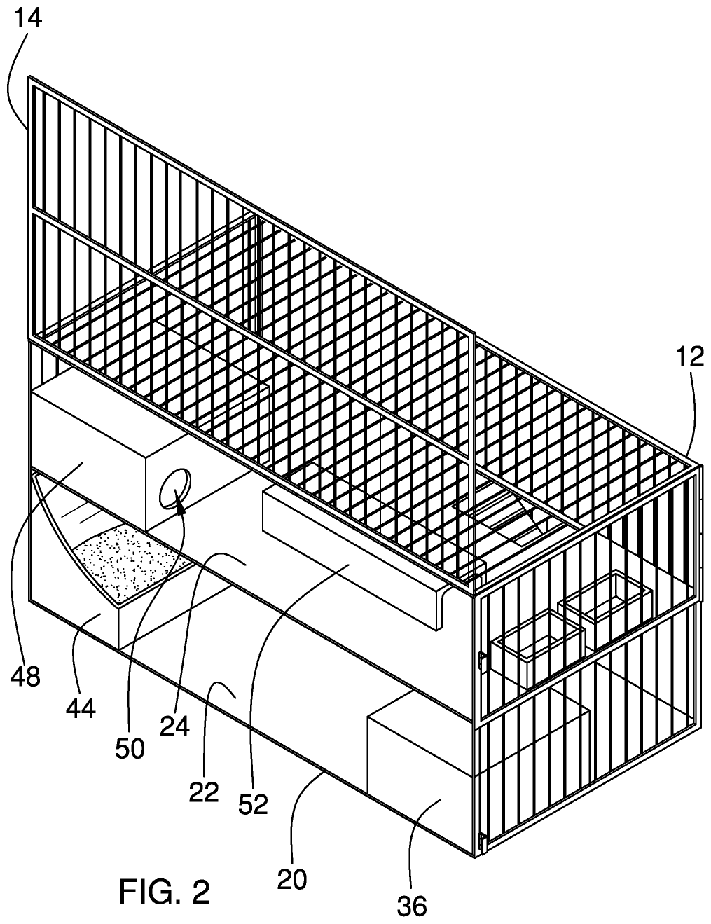

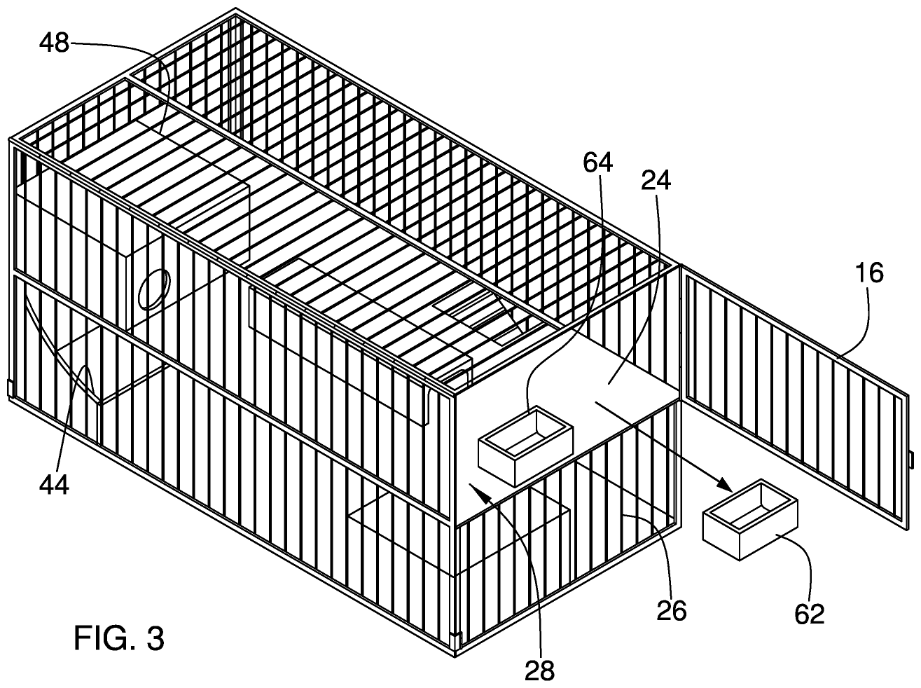

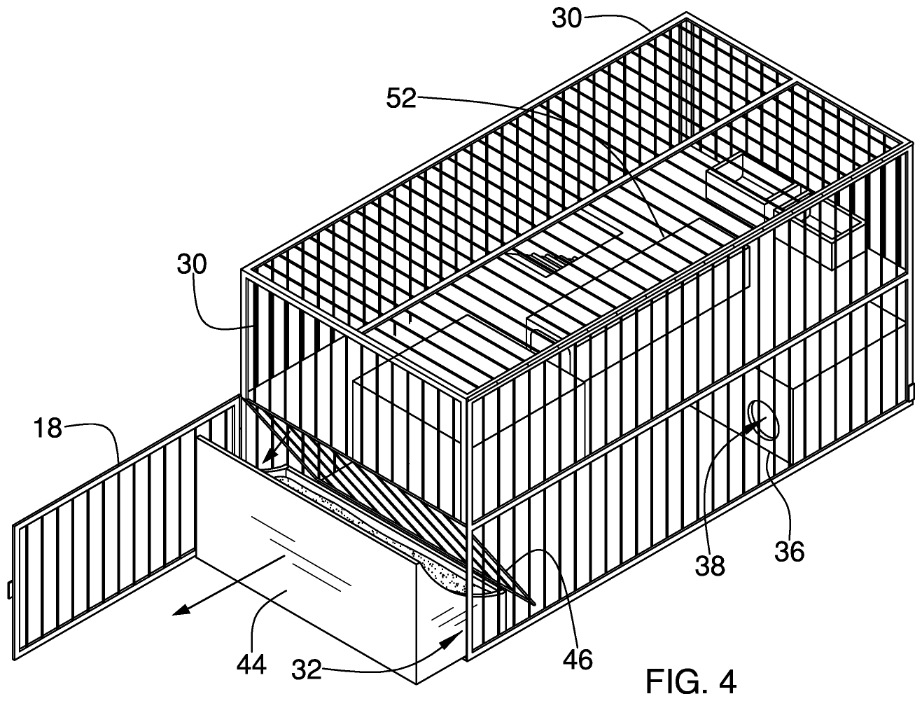

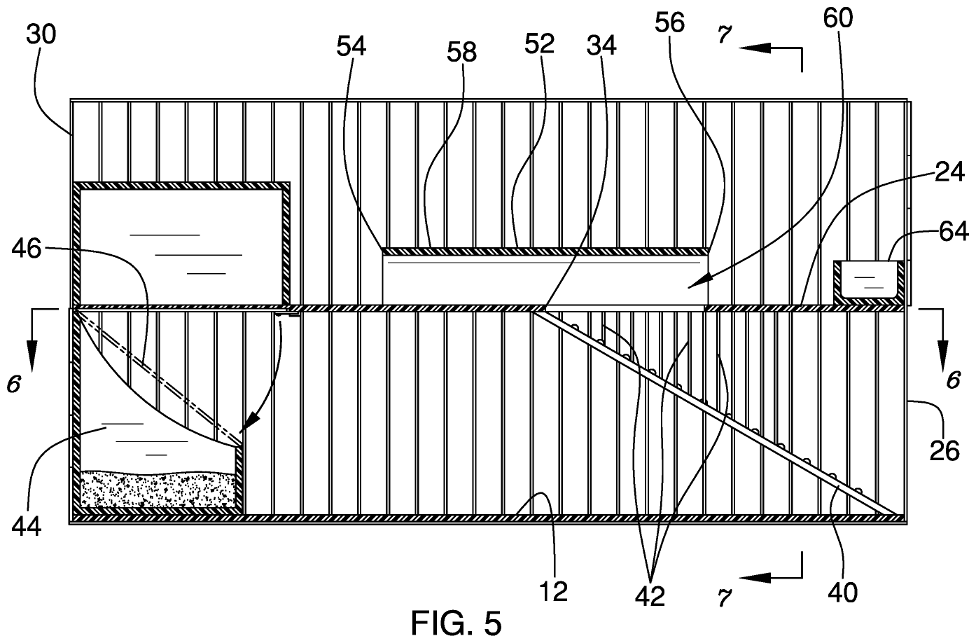

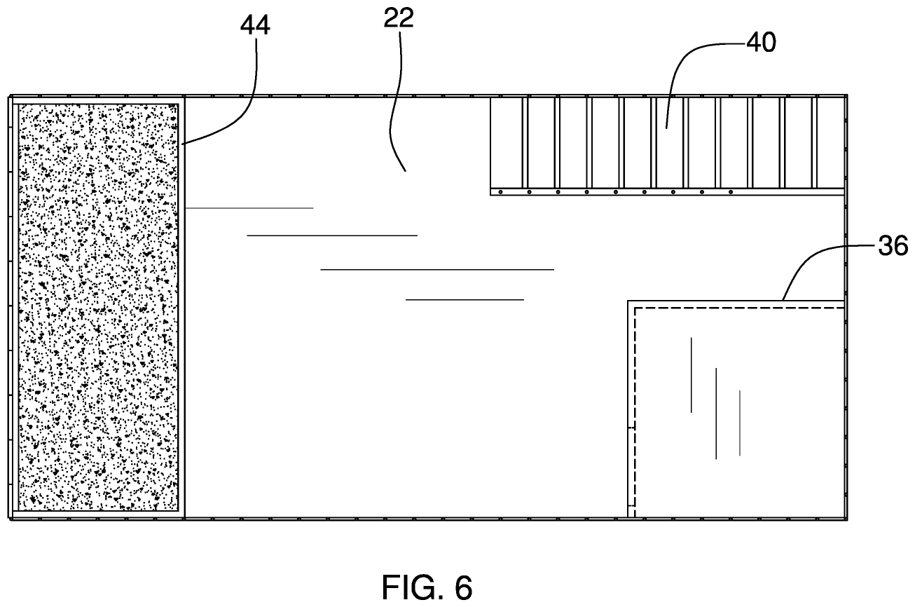

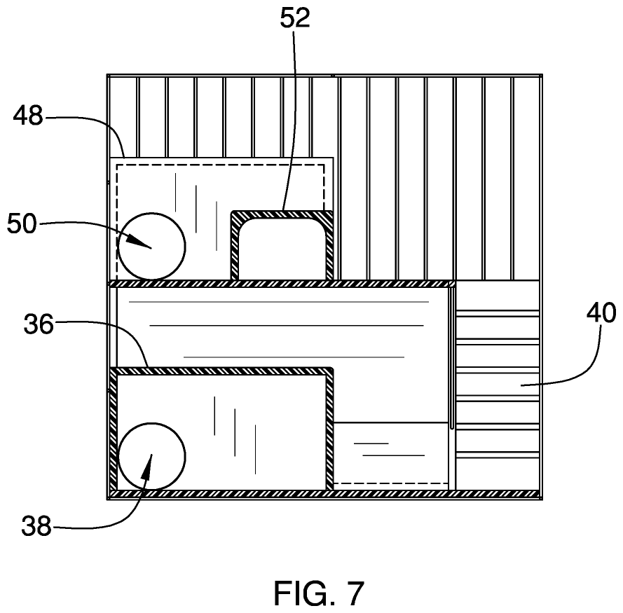

With reference now to the drawings, and in particular to FIGS. 1 through 7 thereof, a new cage device embodying the principles and concepts of an embodiment of the disclosure and generally designated by the reference numeral 10 will be described.

As best illustrated in FIGS. 1 through 7, the ferret cage assembly 10 generally comprises a cage 12 that has a front door 14, a food door 16 and a litter door 18. The cage 12 has a front side 20 that is open into an interior of the cage 12. The cage 12 has a first floor 22 and a second floor 24, and the cage 12 has a first lateral wall 26 that has a food opening 28 extending into the interior of the cage 12. The food opening 28 is aligned with the second floor 24. The cage 12 has a second lateral wall 30 that has a litter opening 32 extending into the interior of the cage 12. The litter opening 32 is aligned with the first floor 22.

The front door 14 is aligned with the front side 20 of the cage 12 for opening and closing the front side 20. The food door 16 is aligned with the food opening 28 for opening and closing the food opening 28. Additionally, the litter door 18 is aligned with the litter opening 32 for opening and closing the litter opening 32. The second floor 24 has an entry 34 extending into the first floor 22.

A lower den 36 is positioned within the cage 12 and the lower den 36 can be occupied by a ferret. The lower den 36 is positioned on the first floor 22 and the lower den 36 has an entry way 38 facing into the interior of the cage 12. Moreover, the lower den 36 is positioned adjacent to the first lateral wall 26 of the cage 12. The lower den 36 has a length that is greater than a height of the lower den 36 for simulating the structure of a ferret den in nature.

A ramp 40 extends between the first floor 22 and the second floor 24 to facilitate the ferret to travel between the first floor 22 and the second floor 24. The ramp 40 includes a plurality of safety bars 42 each extending between the ramp 40 and the second floor 24. In this way the safety bars 42 inhibit the ferret from falling off of the ramp 40. Moreover, the ramp 40 slopes upwardly into the entry 34 in the second floor 24.

A litter box 44 is provided and the litter box 44 is removably positioned in the cage 12 to contain ferret waste. The litter box 44 is slidable outwardly through the litter opening 32 for cleaning the litter box 44. A safety door 46 is hingedly coupled to the second floor 24 and the safety door 46 lies against the second floor 24 when the litter box 44 is positioned in the cage 12. The safety door 46 angles downwardly between the second floor 24 and the first floor 22 when the litter box 44 is removed from the cage 12. In this way the safety door 46 inhibits the ferret from escaping through the litter opening 32 when the litter box 44 is being cleaned.

An upper den 48 is positioned within the cage 12 and the upper den 48 can be occupied by the ferret. The upper den 48 is positioned on the second floor 24 and the upper den 48 has an entry 50 facing the interior of the cage 12. The upper den 48 is positioned adjacent to the second lateral wall 30 of the cage 12. The upper den 48 has a length that is greater than a height of the upper den 48 for simulating the structure of a ferret den in nature.

A tunnel 52 is positioned within the cage 12 and the ferret can crawl therethrough to simulate the ferret's natural behavior. The tunnel 52 has a first end 54, a second end 56 and an outer wall 58 extending therebetween, and the outer wall 58 has an entrance 60 extending therethrough. Moreover, the entrance 60 is aligned with the entry 34 in the second floor 24 thereby facilitating the ferret to move between the tunnel 52 and the ramp 40. The first end 54 is directed toward the entry 50 of the upper den 48 and the second end 56 is directed toward the first lateral wall 26 of the cage 12. The upper den 48, the lower den 36 and the tunnel 52 facilitate horizontal movement within a structure of limited height. In this way the ferret can safely engage in natural behavior while in captivity.

A food dish 62 is provided and the food dish 62 is removably positioned within the cage 12 for feeding the ferret. The food dish 62 is removable through the food opening 28 in the cage 12 for refilling and cleaning. A water dish 64 is removably positioned within the cage 12 for watering the ferret. The water dish 64 is removable through the food opening 28 in the cage 12 for refilling and cleaning.

In use, the ferret is positioned in the cage 12 thereby facilitating the ferret to move between the upper den 48, the tunnel 52, the ramp 40 and the lower den 36. Additionally, the ferret can eat, drink and employ the litter box 44 while the ferret is in the cage 12. The safety door 46 ensures the ferret cannot escape the cage 12 while the litter box 44 is being cleaned. Additionally, the food dish 62 and the water dish 64 are removable from the cage 12 at any time for cleaning and refilling. The front door 14 is opened to facilitate the ferret to enter or exit the cage 12 and to facilitate the cage 12 to be cleaned.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ferret cage assembly having horizontally oriented tunnels and dens for simulating the natural habitat of ferrets, said assembly comprising:
a cage having a front door, a food door and a litter door, said cage having a first floor and a second floor;
a lower den being positioned within said cage wherein said lower den is configured to be occupied by a ferret, said lower den being positioned on said first floor;
a ramp extending between said first floor and said second floor wherein said ramp is configured to facilitate the ferret to travel between said first floor and said second floor;
a litter box being removably positioned in said cage wherein said litter box is configured to contain ferret waste;
an upper den being positioned within said cage wherein said upper den is configured to be occupied by the ferret, said upper den being positioned on said second floor;
a tunnel being positioned within said cage wherein said tunnel is configured to have the ferret crawl therethrough to simulate the ferret's natural behavior;
a food dish being removably positioned within said cage wherein said food dish is configured to feed the ferret; and
a water dish being removably positioned within said cage wherein said water dish is configured to water the ferret.

2. The assembly according to claim 1, wherein:
said cage has a front side being open into an interior of said cage, said cage having a first lateral wall having a food opening extending into said interior of said cage, said food opening being aligned with said second floor, said cage having a second lateral wall having a litter opening extending into said interior of said cage, said litter opening being aligned with said first floor;
said front door is aligned with said front side of said cage for opening and closing said front side;
said food door is aligned with said food opening for opening and closing said food opening;
said litter door is aligned with said litter opening for opening and closing said litter opening; and
said second floor has an entry extending into said first floor.

3. The assembly according to claim 2, wherein said ramp includes a plurality of safety bars each extending between said ramp and said second floor wherein said safety bars are configured to inhibit the ferret from falling off of said ramp, said ramp sloping upwardly into said entry in said second floor.

4. The assembly according to claim 2, wherein said litter box is slidable outwardly through said litter opening for cleaning said litter box.

5. The assembly according to claim 2, further comprising a safety door being hingedly coupled to said second floor, said safety door lying against said second floor when said litter box is positioned in said cage.

6. The assembly according to claim 6, wherein said safety door angles downwardly between said second floor and said first floor when said litter box is removed from said cage wherein said safety door is configured to inhibit the ferret from escaping through said litter opening when said litter box is being cleaned.

7. The assembly according to claim 2, wherein said tunnel has a first end, a second and an outer wall extending therebetween, said outer wall having an entrance extending therethrough, said entrance being aligned with said entry in said second floor thereby facilitating the ferret to move between said tunnel and said ramp, said first end being directed toward an entry of said upper den, said second end being directed toward said first lateral wall of said cage.

8. The assembly according to claim 2, wherein said food dish is removable through said food opening in said cage for refilling and cleaning.

9. The assembly according to claim 2, wherein said water dish is removable through said water opening in said cage for refilling and cleaning.

10. A ferret cage assembly having horizontally oriented tunnels and dens for simulating the natural habitat of ferrets, said assembly comprising:
a cage having a front door, a food door and a litter door, said cage having a front side being open into an interior of said cage, said cage having a first floor and a second floor, said cage having a first lateral wall having a food opening extending into said interior of said cage, said food opening being aligned with said second floor, said cage having a second lateral wall having a litter opening extending into said interior of said cage, said litter opening being aligned with said first floor, said front door being aligned with said front side of said cage for opening and closing said front side, said food door being aligned with said food opening for opening and closing said food opening, said litter door being aligned with said litter opening for opening and closing said litter opening, said second floor having an entry extending into said first floor;
a lower den being positioned within said cage wherein said lower den is configured to be occupied by a ferret, said lower den being positioned on said first floor, said lower den having an entry way facing into said interior of said cage, said lower den being positioned adjacent to said first lateral wall of said cage;
a ramp extending between said first floor and said second floor wherein said ramp is configured to facilitate the ferret to travel between said first floor and said second floor, said ramp including a plurality of safety bars each extending between said ramp and said second floor wherein said safety bars are configured to inhibit the ferret from falling off of said ramp, said ramp sloping upwardly into said entry in said second floor;
a litter box being removably positioned in said cage wherein said litter box is configured to contain ferret waste, said litter box being slidable outwardly through said litter opening for cleaning said litter box;
a safety door being hingedly coupled to said second floor, said safety door lying against said second floor when said litter box is positioned in said cage, said safety door angling downwardly between said second floor and said first floor when said litter box is removed from said cage wherein said safety door is configured to inhibit the ferret from escaping through said litter opening when said litter box is being cleaned;
an upper den being positioned within said cage wherein said upper den is configured to be occupied by the ferret, said upper den being positioned on said second floor, said upper den having an entry facing said interior of said cage, said upper den being positioned adjacent to said second lateral wall of said cage;
a tunnel being positioned within said cage wherein said tunnel is configured to have the ferret crawl therethrough to simulate the ferret's natural behavior, said tunnel having a first end, a second and an outer wall extending therebetween, said outer wall having an entrance extending therethrough, said entrance being aligned with said entry in said second floor thereby facilitating the ferret to move between said tunnel and said ramp, said first end being directed toward said entry of said upper den, said second end being directed toward said first lateral wall of said cage;
a food dish being removably positioned within said cage wherein said food dish is configured to feed the ferret, said food dish being removable through said food opening in said cage for refilling and cleaning; and
a water dish being removably positioned within said cage wherein said water dish is configured to water the ferret, said water dish being removable through said water opening in said cage for refilling and cleaning.
